(19) United States
(12) Patent Application Publication
(10) Pub. No.: US 2023/0139987 A1
(43) Pub. Date: May 4, 2023

(54) HARDWARE ARTIFICIAL NEURAL NETWORK (ANN) ANALOG CIRCUIT, AND METHOD OF USING THEREOF

(71) Applicant: TECHNION RESEARCH & DEVELOPMENT FOUNDATION LIMITED, Haifa (IL)

(72) Inventors: Ramez DANIEL, Haifa (IL); Ilan OREN, Haifa (IL)

(21) Appl. No.: 17/976,084

(22) Filed: Oct. 28, 2022

Related U.S. Application Data
(60) Provisional application No. 63/272,731, filed on Oct. 28, 2021.

(51) Int. Cl. G06N 3/04

(52) U.S. Cl. CPC G06N 3/04

(57) ABSTRACT

A hardware Artificial Neural Network (ANN) analog circuit may include one or more interconnected node circuits. At least one such node circuit may include: two or more first analog circuits, each configured to receive a respective input signal, and produce an exponentiation signal representing a calculation of exponentiation of the respective input signal, by a predetermined respective exponent value; a second analog circuit, configured to produce a multiplication signal, representing a product of the exponentiation signals of the two or more first translinear analog circuits; and a third analog circuit, configured to output an activation signal, based on said multiplication signal.

### CROSS-REFERENCE TO RELATED APPLICATIONS

This application claims the benefit of U.S. Provisional Patent Application No. 63/272,731, filed Oct. 28, 2021 and entitled “TRANSLINEAR SUBTHRESHOLD ANALOG CIRCUITS AND METHOD FOR LOW POWER ARTIFICIAL INTELLIGENCE”, which is hereby incorporated by reference in its entirety.

### FIELD OF THE INVENTION

The present invention relates to the field of Artificial Intelligence (AI). More specifically, the present invention relates to using low-power analog hardware circuits for implementing AI systems.

### BACKGROUND OF THE INVENTION

Existing computational building blocks for implementing Artificial Intelligence (AI) systems are conventionally implemented using digital high power, digital low power, or analog high power architectures, as demonstrated for example in blocks A, B, and C of FIG. 1, respectively. The term “digital” may be used in this context to indicate a system that involves, or requires application of software via a computational device such as a digital processing unit. In a complementary manner, the term “analog” may be used in this context to indicate a system that may perform calculations by dedicated analog circuitry, and does not require application of software via a processing unit.

For example, block A (“Digital, high-power AI”) may be implemented by a cloud computing system, which may include a plurality of digital processing units such as Central Processing Unit (CPU) cores or Graphical Processing Unit (GPU) cores, and may require excessive computing resources and electrical power.

In another example, block B (“Analog, high-power AI”) may include an analog circuit, which includes a plurality of analog electrical components (e.g., resistors, transistors, etc.), tailored for a specific AI task. For example, currently available analog, high-power AI solutions apply the Ohm law of voltages, to conclude a multiplication of signals, and apply the Kirchoff law of currents to conclude a sum of electrical signals. Such implementation would require operational amplifiers and transistors that are tuned to work in their active work mode (i.e., not within the subthreshold work mode), and thus draw significant currents, leading to high power consumption.

It may be appreciated that when using building blocks such as block A and/or block B for implementing large AI systems, the power consumption, and/or computational requirements often become a limiting factor.

In another example, block C (“Digital, low-power AI”) may be an analog circuit, which includes a plurality of electrical components (e.g., resistors, transistors, etc.), tailored for a specific AI task, and tuned to work in a low power-consumption mode. However, currently available low-power AI solutions require that the tailored analog circuit be adjoined with a dedicated computing device (hence referred to as a digital, low-power solution).

### SUMMARY OF THE INVENTION

As demonstrated by block D of FIG. 1, embodiments of the invention may provide a practical application for ultra-low power analog (e.g., devoid of a processing unit) circuits with training capabilities, which can be used as building blocks for low power AI systems. The term “ultra-low”, in relation to power consumption (e.g., of an AI system according to embodiments of the invention) may be used in this context as a quantitative assessment of power, to indicate a level of power consumption that is lower (e.g., in one or more orders of magnitude) in relation to functionally equivalent systems (e.g., currently available AI systems).

Embodiments of the invention may include an analog hardware circuit, referred to herein as a “node” analog hardware circuit or a “perceptgene” analog hardware circuit. In this context, the terms “node” circuit and “perceptgene” circuit may be used herein interchangeably.

According to some embodiments, and as elaborated herein, the node or perceptgene circuit may be uniquely designed or tuned to work in the subthreshold work mode, thus implementing a computational building block that may consume an ultra-low level of power. This may, in turn, facilitate implementation of ultra-low power AI systems.

Additionally, as elaborated herein, several similarities exist between the deterministic, as well as stochastic behavior of transistors working in the subthreshold work mode and mathematical models governing chemical reactions. A perceptgene may be implemented using subthreshold analog circuitry, to exploit such similarities, and thus mimic, or model the behavior of biochemical reactions such as genetic processes, and the synthesis of proteins in a biological environment. In other words, a combination or a structure containing one or more perceptgene circuits may be used to simulate, or predict an outcome of complex biological processes. Such a structure of one or more perceptgene circuits may produce such a prediction effectively (e.g., producing an accurate result), while performing several orders of magnitude faster than existing simulators, and requiring an ultra-low level of power.

Embodiments of the invention may include a hardware Artificial Neural Network (ANN) analog circuit that may include one or more interconnected node circuits. At least one (e.g., each) node circuit may include: (a) two or more first analog circuits, each configured to receive a respective input signal, and produce an exponentiation signal representing a calculation of exponentiation of the respective input signal, by a predetermined respective exponent value; (b) a second analog circuit, configured to produce a multiplication signal, representing a product of the exponentiation signals of the two or more first translinear analog circuits; and (c) a third analog circuit, configured to output an activation signal, based on said multiplication signal.

According to some embodiments, the two or more first analog circuits may be translinear analog circuits, and the second analog circuit may be a translinear analog circuit.

Additionally, or alternatively, the two or more first analog circuits may each include one or more transistors, tuned to operate in the transistor subthreshold region, thus producing the exponentiation signal in a translinear work mode. Additionally, or alternatively, the second analog circuit may include one or more transistors, tuned to operate in the transistor subthreshold region, thus producing said multiplication signal in a translinear work mode.

According to some embodiments, the one or more node circuits may be interconnected such that the output activation signal of at least one first node circuit serves as an input signal of at least one second node circuit.

According to some embodiments, the ANN circuit may include an input layer of node circuits, adapted to receive an input vector that may include one or more input signals; and an output layer of node circuits, adapted to emit an output signal based on the activation signal of the output layer node circuits. The ANN circuit may be trained such that the output signal represents a classification of the one or more input signals.

Additionally, or alternatively, the two or more first analog circuits may include an adjustable weight hardware element, configured to determine the exponent value.

According to some embodiments the ANN circuit may include, or may be associate with a training module, configured to train the ANN by: receiving an input vector, that may include one or more input signals of the two or more first analog circuits; receiving supervisory data, corresponding to the input vector, wherein said supervisory data represents a desired value of one or more activation signals, in response to the input vector; and adjusting the weight hardware element of at least one first analog circuit, based on the input vector and the supervisory data.

According to some embodiments at least one first analog circuit may include an adjustable bias hardware element, configured to determine a bias value of the first analog circuit. The training module may be further configured to adjust the bias hardware element of at least one first analog circuit, based on the input vector and the supervisory data.

Additionally, or alternatively, the training module may be configured to adjust the weight hardware element by adjusting an impedance of the weight hardware element, so as to redetermine the exponent value of the relevant first analog circuit.

Embodiments of the invention may include a node analog hardware circuit, that may include: (a) two or more exponentiation analog circuits, each configured to receive a respective input signal, and produce an exponentiation signal representing a calculation of exponentiation of the respective input signal, by a predetermined, respective exponent value; (b) a multiplication analog circuit, configured to produce a multiplication signal, representing a product of the exponentiation signals of the two or more exponentiation analog circuits; and (c) an activation analog circuit, configured to output an activation signal based on said multiplication signal. The exponentiation analog circuits and multiplication analog circuit may be configured to work in a translinear work mode, and the activation signal may represent a predicted value of a product of a biochemical process.

For example, the activation signal may represent a predicted value of a product of the biochemical process, according to the Michaelis-Menten function.

According to some embodiments, at least one input signal may be a concentration parameter value, representing a concentration of a protein involved in the biochemical process. Additionally, or alternatively, at least one exponent value may represent a hill coefficient of a protein involved in the biochemical process.

Embodiments of the invention may include a network analog hardware circuit, also referred to herein as an ANN circuit. The ANN circuit may include a plurality of interconnected node analog hardware circuits. In such embodiments, at least one input of a first node analog hardware circuit may include a weighted function (e.g., a weighted product) of one or more activation signals output by one or more respective second node analog hardware circuits.

According to some embodiments, at least one activation signal of the plurality of node analog hardware circuits may include a prediction of an outcome of a biochemical process.

Embodiments of the invention may include a method of implementing an Artificial Intelligence (AI) function or machine learning (ML) function. Embodiments of the method may include providing a network analog hardware circuit (e.g., ANN circuit), that may include a plurality of interconnected analog hardware node circuits (or “node circuits” for short). The plurality of node circuits may include at least (a) an input layer of node circuits, adapted to receive an input vector that may include one or more input signals, and (b) an output layer of node circuits, adapted to emit an output signal. Embodiments of the invention may include training the network analog hardware circuit such that the output signal represents application of a predetermined AI function or ML, function on the one or more input signals.

As elaborated herein, one or more node circuits of the plurality of node circuits may include two or more exponentiation analog circuits, each configured to receive a respective input signal, and produce an exponentiation signal representing a calculation of exponentiation of the respective input signal, by a predetermined, respective exponent value. Additionally, or alternatively, one or more node circuits of the plurality of node circuits may include a multiplication analog circuit, configured to produce a multiplication signal, representing a product of the exponentiation signals of the two or more exponentiation analog circuits. According to some embodiments, the exponentiation analog circuits and multiplication analog circuit may be configured to work in a translinear work mode.

Additionally, or alternatively, one or more node circuits of the plurality of node circuits may include an activation analog circuit, configured to emit an activation signal based on said multiplication signal. The output signal may be, may be derived of, or may include the activation signal of the output layer node circuits.

According to some embodiments, at least one input of a first node analog hardware circuit of the ANN circuit may include a weighted function of one or more activation signals output by one or more respective second node analog hardware circuits.

According to some embodiments, the AI function may be, or may include prediction of an outcome of a biochemical process, such as synthesis of a protein in a simulated biological cell. In such embodiments, at least one input signal may be a concentration parameter value, which may represent a concentration of a protein involved in the biochemical process. Additionally, or alternatively, at least one exponent value may represent a hill coefficient of a protein involved in the biochemical process. In such embodiments, at least one activation signal of the plurality of node analog hardware circuits may be or may include a prediction value, which may represent a predicted outcome of the biochemical process (e.g., quantity or rate of a simulated synthesized protein in a simulated biological cell).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram depicting currently available solutions for implementation of computational AI building blocks (e.g., blocks A, B and C), and a solution for implementing of computational AI building blocks according to some embodiments of the invention (e.g., block D);

FIG. 2 is a schematic diagram, depicting a biochemical process 200 (e.g., a genetic process), in which one or more inducers may activate transcription factors, which in turn may bind to promotors in order to regulate creation of a protein;

FIG. 3 is a block diagram depicting an aspect of functionality of a perceptgene analog hardware circuit, according to embodiments of the present invention;

FIGS. 4A and 4B are schematic circuit diagrams depicting examples of implementation of perceptgene analog hardware circuits, based on metal oxide semiconductor field-effect transistor (MOSFET) technology and bipolar transistor technology respectively, according to embodiments of the present invention;

FIG. 5 is a schematic circuit diagram, depicting an example of an implementation of an exponentiation circuit, which may be included in a perceptgene analog hardware circuit, according to embodiments of the present invention;

FIG. 6 is a schematic circuit diagram, depicting an example of an implementation of a multiplication circuit, which may be included in a perceptgene analog hardware circuit, according to embodiments of the present invention;

FIG. 7 is a schematic circuit diagram, depicting an example of an implementation of an activation circuit, which may be included in a perceptgene analog hardware circuit, according to embodiments of the invention;

FIG. 8 is a schematic block diagram depicting an example of implementation of an Artificial Neural Network (ANN) analog hardware circuit, consisting of a plurality of interconnected perceptgene or node circuits, according to some embodiments of the invention;

FIG. 9 is a schematic block diagram depicting an example of implementation of a perceptgene hardware analog circuit, which may include, or may be associated with, a training or tuning module, according to some embodiments of the invention; and

FIG. 10 is a flow diagram depicting a method of implementing an Artificial Intelligence (AI) function or ML function, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights.

Embodiments of the present invention may be based on a computational unit that is referred to herein as a “perceptgene” analog circuit. The computation concepts of the perceptgene unit are described in a pending U.S. patent application Ser. No. 16/626,824 to the Technion (who is the applicant for the current application), which is included herein in its entirety.

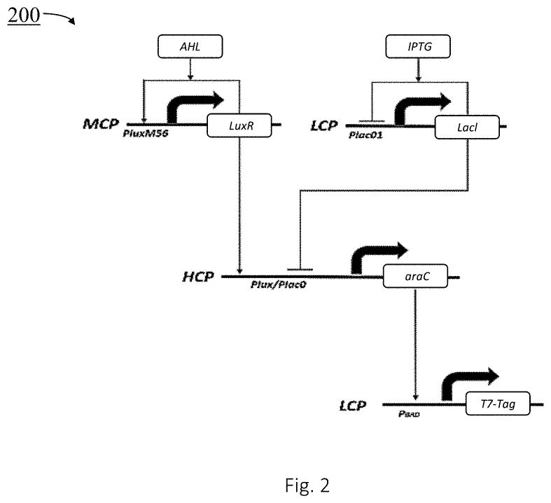

Reference is now made to FIG. 2 which is a schematic diagram, depicting a biochemical process 200 (e.g., a genetic process), in which one or more inducers may activate transcription factors, which in turn may bind to promotors in order to regulate creation of a protein.

According to some embodiments, the perceptgene computational unit (e.g., the perceptgene circuit) may mathematically describe a biochemical process (e.g., a genetic process) such as the process in the example of FIG. 2, in which inducers activate transcription factors which bind to promotors in order to regulate the creation of a protein.

For example, in the genetic process example demonstrated in FIG. 2, AHL and IPTG are proteins, acting as inducers for regulating production of an araC protein. The AHL inducer may bind to a PluxM56 Medium Copy Plasmid (MCP) to promote transcription of a Messenger Ribonucleic Acid (mRNA) molecule that codes an LuxR protein. The IPTG inducer may bind to a Plac01 Low Copy Plasmid (LCP) to inhibit transcription of an mRNA molecule that codes an Lad protein. The subsequent products (e.g., the LuxR and Lacl proteins) may in turn bind to a Plux/Plac0 High Copy Plasmid (HCP), to promote transcription of the araC protein. It may be appreciated by a person skilled in the art that the process of producing transcription of the araC protein as described above may be mathematically represented according to the power law and multiplication equation (Eq. 1) below:

$$Y 1 = Ym 1 {( \frac{AHL}{Km 1} )}^{n 1} {( \frac{IPTG}{Km 2} )}^{n 2} \qquad Eq . 1$$

where: Y1 represents a concentration of the araC protein; (AHL/Km1) represents a concentration of the AHL inducer protein; (IPTG/Km2) represents a concentration of the IPTG inducer protein; n1 represents a hill coefficients, corresponding to an affinity of the AHL inducer protein to the respective PluxM56 plasmid; and n2 represents a hill coefficient, corresponding to an affinity of the IPTG inducer protein to the respective Plac01 plasmid.

In a subsequent stage of the modelled biochemical process, the araC protein is binding to a Pbad LCP, to promote regulation of the T7-Tag protein, according to the Michalis-Menten equation (Eq. 2) below.

$$Yt = Y max \frac{{( \frac{Y}{Kd} )}^{m} + β}{{( \frac{Y}{Kd} )}^{m} + β + 1} \qquad Eq . 2$$

where Y is the input transcription factor from a previous stage (e.g., the output of the multiplication module, or Mult_out, such as the value of araC); β is a basal level of the relevant promoter (e.g., a noise level output signal when there is no input); Kd is a dissociation constant of binding Y to a promoter (ex: araC to Pbad); and m is a Hill-coefficient (e.g., a number of binding sites within the promoter).

As known in the art, the Michalis-Menten model is a simple model to account for the kinetic characteristics of enzyme activity as a function of time for a series of substrate concentrations.

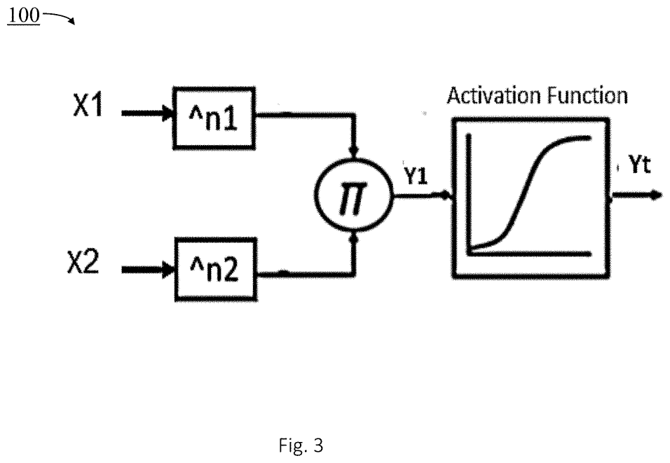

Reference is now made FIG. 3 which is a block diagram depicting an aspect of functionality of a perceptgene analog hardware circuit 100 (also referred to herein as a “perceptgene model” or a “node” circuit), according to embodiments of the present invention.

As shown in FIG. 3, a perceptgene circuit or model 100 may implement the functions of equations Eq. 1 and Eq. 2. For example, the inputs X1 and X2 may represent a concentration of material (e.g., a concentration of inducer proteins, such as (AHL/Km1) and (IPTG/Km2)) that may be included in a modeled biochemical process. X1 and X2 may be exponentiated by a power of n1 and n2, respectively, and the result is multiplied in order to form the power law equation (Eq. 1). The multiplication result (e.g., Y1 of Eq. 1) may drive an activation function based on the Michaleis-Menten equation in order to generate the output Yt.

According to some embodiments, and as elaborated herein, the perceptgene functionality may be implemented using subthreshold analog circuit which may exploit similarities between deterministic and/or stochastic behavior of transistors of the analog circuit and the mathematical models governing chemical reactions. In other words, the perceptgene analog circuit may mimic the behavior of genetic processes which are widely observed in many biological processes, and may therefore be used to simulate complex biological processes effectively, rapidly and do so while consuming ultra-low levels of power.

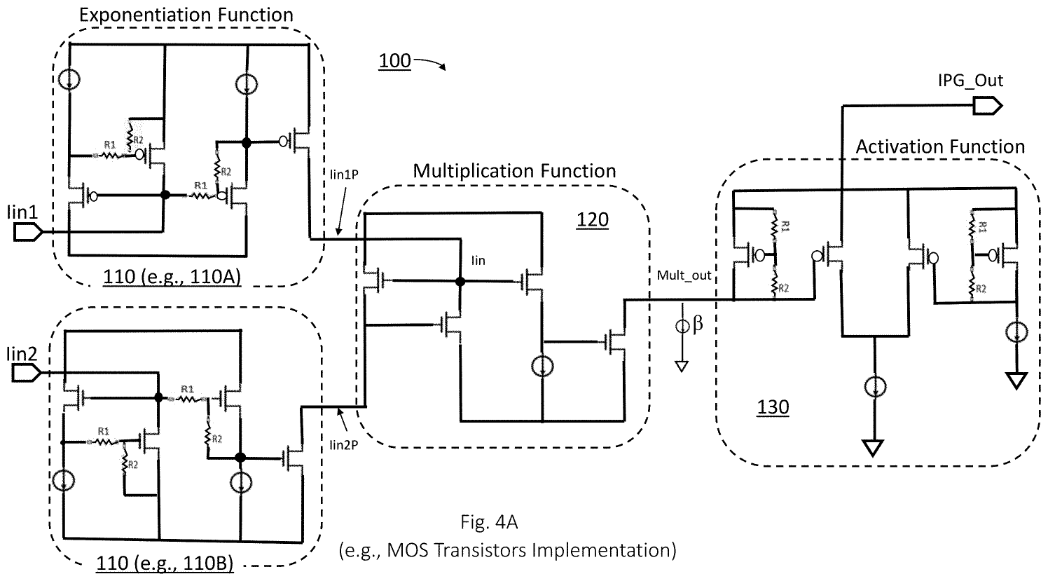

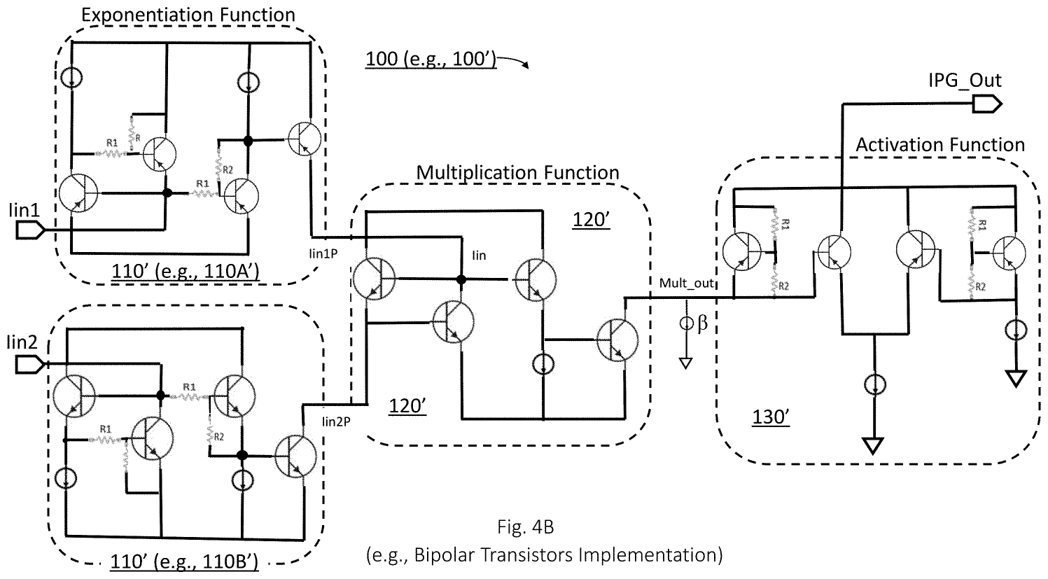

Reference is now made to FIGS. 4A and 4B, which are schematic circuit diagrams depicting examples of implementation of perceptgene analog hardware circuits 100, based on Metal Oxide Semiconductor (MOS, e.g., Field-Effect Transistor MOS (MOSFET), Complementary MOS (CMOS), etc.) technology and Bipolar Junction Transistor (BJT) technology respectively, according to embodiments of the present invention.

The term “translinear” (e.g., as representing a translinear electrical component or circuit) may be used herein to refer to an electrical element that carries out its function using the translinear principle. Such elements may include current-mode electrical components or circuits consisting of transistors (e.g., BJT transistors and CMOS transistors in weak inversion) which obey an exponential current-voltage characteristic.

The translinear principle is that in a closed loop containing an even number of translinear elements with an equal number of them arranged clockwise and counter-clockwise, the product of the currents through the clockwise translinear elements equals the product of the currents through the counter-clockwise translinear elements. In other words, the translinear principle facilitates transition between a representation of a sum of currents per Kirchoff s voltage law (e.g., that the directed sum of voltages around any closed loop is zero), and a representation of a product of currents in a translinear circuit.

The term “subthreshold” (as in “subthreshold region” or “subthreshold work mode”) may refer to a work mode of a transistor (e.g., a MOS transistor), in which the transistor exhibits exponential current-voltage characteristics, and therefore may be regarded as a translinear element.

According to some embodiments, the one or more MOSFET transistors of FIG. 4A may be tuned to work in the subthreshold region. Therefore, at least a portion of perceptgene circuit 100 as implemented in the example of FIG. 4A may be tuned to work as a translinear analog circuit. In a complementary manner, at least a portion of perceptgene circuit 100 as implemented in the example of FIG. 4B may be tuned to work as a translinear analog circuit.

As shown in FIGS. 4A and 4B, perceptgene circuit 100 may include a plurality of circuits (or sub-circuits, as referred to herein), which may implement the mathematical functions required for the perceptgene computing model, as described herein.

According to some embodiments, perceptgene circuit 100 may include two or more exponentiation analog circuits 110/110′ (e.g., 110A, 110A′, 110B, 110B′), each configured to receive a respective input signal Iin (e.g., Iin1, Iin2), and produce an exponentiation signal IinP (e.g., Iin1P, Iin2P) representing a calculation of exponentiation of the respective input signal, by a predetermined, respective exponent or power value ‘n’. In other words, exponentiation signal IinP (e.g., Iin1P, Iin2P) may represent a calculated exponentiation value as elaborated in equation Eq. 3, below:

IinP=Iie\hat{ }n, Eq. 3

where Iin is the input (e.g., Iin1, Iin2), and n is the predetermined exponent or power value.

It may be appreciated by a person skilled in the art that the exponent or power value ‘n’ may be determined according to specific values of elements in exponentiation analog circuits 110/110′, such as an impedance of resistors R1 and R2.

Pertaining to the example of the biochemical process of FIG. 2, at least one input signal Iin (e.g., Iin1, Iin2) may be a concentration parameter value (e.g., (AHL/Km1), (IPTG/Km2)) that may represent a concentration of a protein (e.g., an inducer protein) that may be involved in the biochemical process as elaborated herein (e.g., in relation to FIG. 2). Additionally, the at least one power or exponent value ‘n’ may represent a hill coefficient (e.g., n1, n2) of a protein that may be involved in the biochemical process as elaborated herein (e.g., in relation to FIG. 2).

According to some embodiments of the invention, the two or more equalization analog circuits 110/110′ may be configured to work as translinear analog circuits. For example, the two or more equalization analog circuits 110/110′ may include one or more transistors (e.g., MOS transistors) tuned to operate in the transistor subthreshold region, thus producing exponentiation signal IinP (Iin1P, Iin2P) in a translinear work mode.

According to some embodiments, perceptgene circuit 100 may include a multiplication analog circuit 120/120′, configured to produce a multiplication signal (denoted “Mult_out”), representing a product of the exponentiation signals IinP (e.g., Iin1P, Iin2P) of the two or more exponentiation analog circuits 110/110′. In other words, Mult_out may be calculated as Mult_out=Iin1P*Iin2P.

It may be appreciated that the combined functionality of exponentiation analog circuits 110/110′ and multiplication analog circuit 120/120′ may implement the calculation of power law and multiplication equation as elaborated by Eq. 1.

According to some embodiments, multiplication circuit 120 may be configured to work as a translinear analog circuit. For example, multiplication circuit 120 may include one or more transistors (e.g., MOS transistors), tuned to operate in the transistor subthreshold region, thus producing multiplication signal Mult_out in a translinear work mode.

According to some embodiments, perceptgene circuit 100 may include an activation analog circuit 130/130′, configured to output an activation signal (denoted “IPG_Out”) based on multiplication signal Mult_out. Activation analog circuit 130/130′ may serve as a decision making circuit, based on the Michaelis-Menten equation.

In other words, activation analog circuit 130/130′ may be tuned to produce activation signal IPG_Out based on an input of multiplication signal Mult_out, according to the Michalis-Menten equation (e.g., Eq. 2) elaborated herein (e.g., in relation to the example of FIG. 2).

In other words: The output of multiplication module 120, e.g., the signal Mult_out, may correspond to the element ‘Y’ of Eq. 2 (e.g., the Michaelis-Menten function); Activation signal IPG_Out, e.g., the output of activation module 130 may represent a predicted value of a product (e.g., a T7-Tag protein) of the biochemical process, and may correspond to Yt of Eq. 2 (e.g., the Michaelis-Menten function); The value of Beta (β) in Eq. 2 may be set by a current source at the input of Activation Function (marked ‘β’ in FIGS. 4A, 4B); and the value ‘m’ may be set by selecting or configuring the resistors of activation module 130.

According to some embodiments, exponentiation analog circuits 110 and multiplication analog circuit 120 circuits may be configured to work in a translinear work mode, to implement their respective functions (e.g., exponentiation and multiplication) based on circuit current levels.

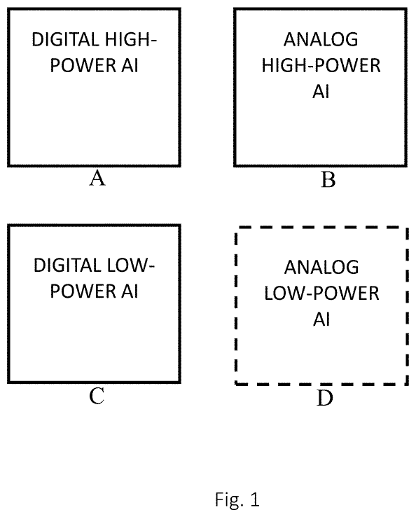

Additionally, the MOSFET implementation of exponentiation analog circuits 110 and multiplication analog circuit 120 circuits (e.g., as depicted in FIG. 4A) may be tuned to perform their respective functions in the subthreshold region, and may therefore consume ultra-low amounts of power. Therefore, according to some embodiments of the invention, MOSFET implementations of the perceptgene analog circuit 100 may be used as nodes, or building blocks for large, scalable, low power analogue AI systems (e.g., such as element D of FIG. 1).

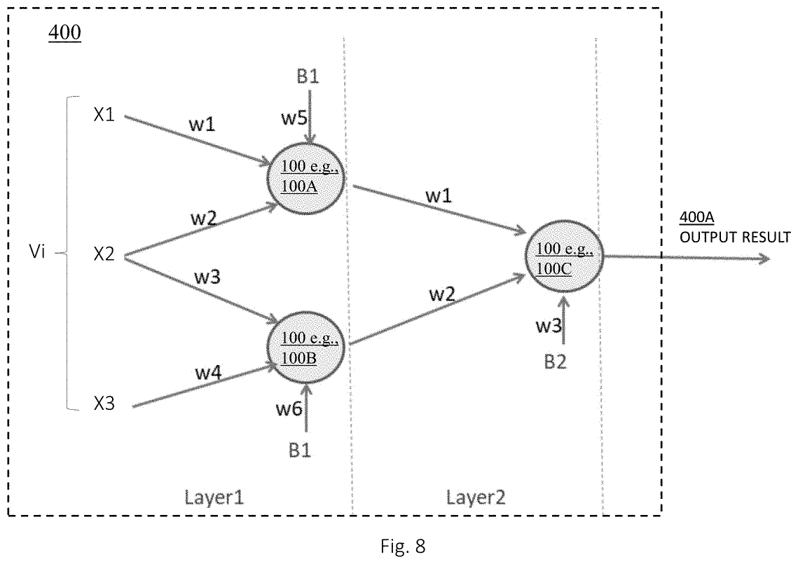

For example, as elaborated herein (e.g., in relation to FIG. 8), perceptgene circuit 100 may be used as a building block for a hardware ANN analog circuit, which may include a single perceptgene circuit 100 or a plurality of interconnected perceptgene circuits 100. In this context, perceptgene circuit 100 may be referred to as a “node circuit” 100, in a sense that each perceptgene circuit 100 in the ANN may be considered as a node of the ANN network.

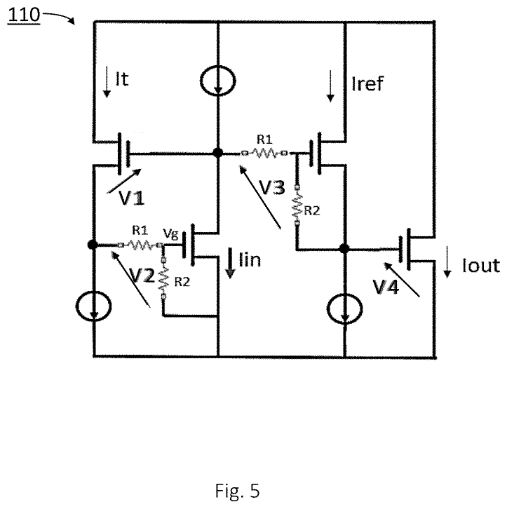

Reference is now made to FIG. 5, which is a schematic circuit diagram, depicting an example of an implementation of an exponentiation circuit 110, which may be included in a perceptgene analog hardware circuit 100, according to embodiments of the present invention.

According to some embodiments, exponentiation circuit 110 may be similar to the multiplication circuit discussed below except for the addition of resistors (R1, R2) which are connected to the gates of the exponentiation circuit 110 transistors. These resistors are connected as voltage dividers and thus define the gate voltage of the transistors. The relation between these resistors may be used to define the power constant n (e.g. n1, n2). The transistors in the circuits operate at the subthreshold regions and thus the current through them is an exponential function of their gate voltage. Summation of the voltages over a close loop shows that the output current Tout will be a function of the input current Iin with power n as described in Eq. 4 below. The perceptgene 100 as the well-known perceptron model can be configured to implement different classifiers. The resistor values of the power circuit can be configured and thus function as the weights in order to implement any ANN.

$$Iout = \frac{{lin}^{n}}{C} \qquad Eq . 4$$

where the power factor n may be set according to the values of resistors R1, R2 according to Eq. 4.1, below:

$$n = \frac{R 1 + R 2}{R 2} \qquad Eq . 4.1$$

And where the constant C may be set by the magnitude of currents I_{ref} and Iₜ according to Eq. 4.2, below:

$$C = \frac{{Iref}^{n}}{It} \qquad Eq . 4.2$$

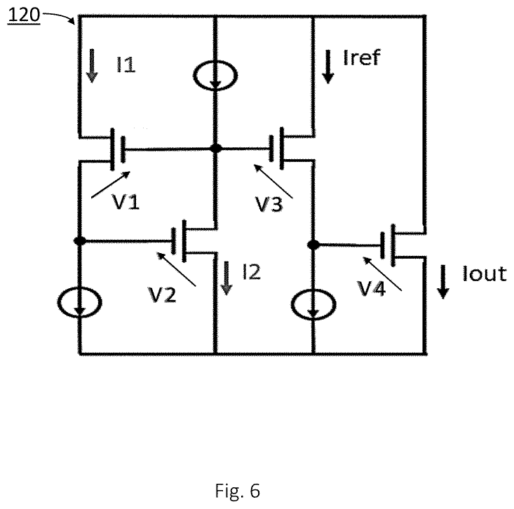

Reference is now made to FIG. 6, which is a schematic circuit diagram, depicting an example of an implementation of a multiplication circuit 120, which may be included in a perceptgene analog hardware circuit 100, according to embodiments of the present invention.

According to some embodiments, multiplication circuit 120 of FIG. 6 may be the same as circuit 120 of FIGS. 4A/4B. In such embodiments, (a) The inputs to the circuit of FIG. 6 are represented by the current sources on the first and second branches, which cause the current Iin1 and Iin2 in those branches (corresponding to Iin1P and Iin2P in FIG. 4A, respectively); and (b) Iref of FIG. 6 corresponds to the current source of multiplication circuit 120 in FIG. 4A.

According to some embodiments, all the transistors of multiplication circuit 120 may be configured to operate at the subthreshold region, so that the current through them may be expressed as an exponential function of their gate voltage. Summation of the voltages over the close loop of the transistors can show that the output current Iₒᵤₜ is a multiplication function of the input currents I₁, I₂ as described in Eq. 5, below:

Iout=(I₁*I₂)/I_{ref} Eq. 5

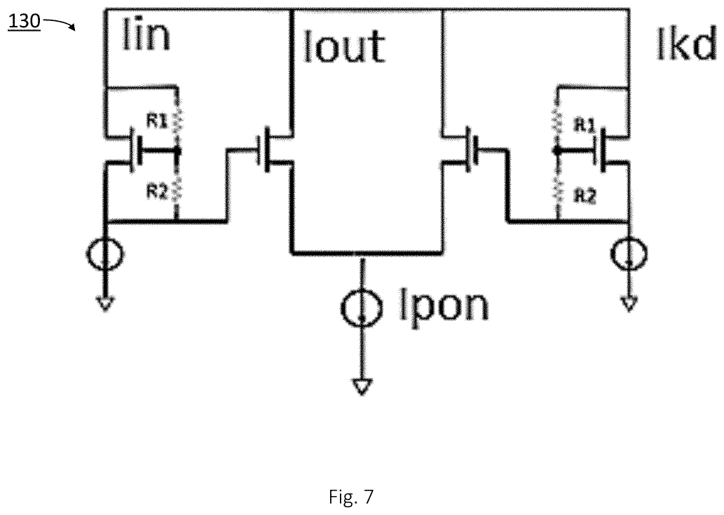

Reference is now made to FIG. 7, which is a schematic circuit diagram, depicting an example of an implementation of an activation circuit 130, which may be included in a perceptgene analog hardware circuit 100, according to embodiments of the invention. According to some embodiments, activation circuit 130 of FIG. 7 may be the same as circuit 130 of FIGS. 4A/4B.

According to some embodiments, activation function circuit 130 may serve as a decision-making circuit, implementing the Michaelis-Menten equation (Eq. 2), and may generate a result (e.g., IPG_Out of FIG. 4A, which corresponds to Iₒᵤₜ of FIG. 7) based on the output of multiplication circuit 120.

As shown in FIG. 7, the nonlinear activation function circuit 130 may be based on a differential pair and two current mirror circuits. Due to the symmetry of the circuit and the fact that the total current of the differential pair is the summation of the currents on its branches, the output current follows the Michaelis-Menten equation (Eq. 2).

According to some embodiments, circuit 130 may also include resistors R1, R2 that may function as a voltage divider. This voltage divider may set the gate voltage of the transistors, and define the power m of the function as described in Eq. 6, below:

$$Iout = Ipon ⋆ \frac{{Iin}^{m}}{{Iin}^{m} + {Ikd}^{m}} \qquad Eq . 6$$

The perceptgene circuit may have various applications both in AI system design and in the biology research. The following are examples of such applications:

Perceptgene circuit 100 may be used for building basic classifiers by defining its resistors values through a training procedure. Such classifiers can be connected together to form an ANN for different usages.

Since the perceptgene circuits may be implemented as subthreshold circuits, ANN's which will be implemented by perceptgene circuit according to embodiments of the present invention will consume ultra-low power and thus can be used for implementation of ultra-low power AI systems. This ultra-low power implementation capability is valuable for AI companies which are targeting products for hand-held, and wearable AI devices. AI products which are doing the computing over the cloud due to power limitations may benefit from this invention.

The similarity between the perceptgene model and some biological processes enables the use of the perceptgene circuit 100 as described herein, to simulate basic biological processes. Building fast and reliable simulators for biological processes can have a great use for synthetic biology research.

The perceptgene circuit may also be used as a building block for expandable emulator of complex biology systems. Emulating the response of complex biological systems like organs to drugs or cosmetic materials for example, might be valuable for the pharma and cosmetics companies which can avoid the needs for vivo expensive and complex testing.

Reference is now made to FIG. 8, which is a schematic block diagram depicting an example of implementation of an ANN analog hardware circuit 400, consisting of one or more (e.g., a plurality) of interconnected perceptgene or node circuits 100, according to some embodiments of the invention.

For example, the one or more perceptgene or node circuits 100 may be interconnected such that the output activation signal of at least one first node circuit (e.g., 100A, 100B) may serve as an input signal of at least one second node circuit (e.g., 100C). Additionally, or alternatively, at least one input of a first node analog hardware circuit (e.g., 100C) may be, or may include a weighted function (e.g., a weighted product) of one or more activation signals (e.g., IPG_Out) that are output, or emitted by one or more respective, other node analog hardware circuits 100 (e.g., 100A, 100B).

As shown in FIG. 8, ANN circuit 400 may include several layers of perceptgene circuits 100. It may be appreciated that a perceptgene of the present invention may construct an ANN in a similar manner that a perceptron with one or more inputs (denoted Xi, i∈1, 2, 3) with different weights (denoted Wi i∈[1, 6]) and bias signals (denoted Bi, i∈1, 2).

For example, ANN circuit 400 may include an input layer of node circuits 100, adapted to receive an input vector that may include one or more input signals (e.g., X1, X2, X3) and an output layer of node circuits 100, adapted to emit an output signal 400A based on the activation signal (e.g., IPG_Out of FIG. 4A) of the output layer node circuits (e.g., 100C). In some embodiments, ANN circuit 400 may be configured, or trained such that output signal 400A may represent a classification of the one or more input signals (e.g., X1, X2, X3). Additionally, or alternatively, the at least one activation signal (e.g., IPG_Out of FIG. 4A) of the plurality of node analog hardware circuits 100 may include, or may represent a prediction of an outcome of a biochemical process.

According to some embodiments, the two or more exponentiation circuits 110 may include an adjustable weight hardware element, which may determine the exponent or power value n (e.g., n1, n2). In order to implement a specific ANN 400 function, the adjustable weight hardware elements of ANN 400 need to be set to the correct values using a training algorithm, as elaborated herein.

For example, the adjustable weight hardware elements of exponentiation circuits 110 may include transistors or resistors, such as elements R1, R2 of FIG. 5. In such embodiments R1 and/or R2 may be, or may include a current-controlled resistor (CCR) a voltage controlled resistor (VCR), or the like. Adjusting a value of an impedance value of R1 and/or R2 may (e.g., the CCR or VCR component) may adjust a value of the exponent or power value n (e.g., n1, n2).

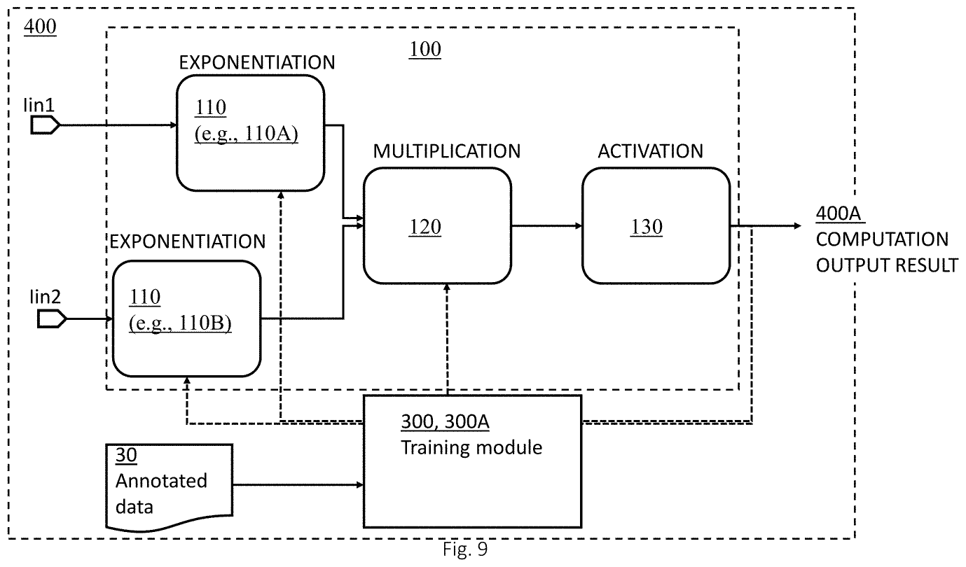

Reference is now made to FIG. 9, which is a schematic block diagram depicting an example of implementation of a perceptgene hardware analog circuit 100, that may be included in an ANN circuit 400, facilitating training or tuning functionality. In other words, ANN circuit 400 may include one or more node or perceptgene circuits 100 and a training circuit or module 300, adapted to control the parameters of the one or more circuits 100 according to a training process. Module 300 may be implemented as a hardware module, a software module, or any combination thereof.

According to some embodiments, training module 300 may receive one or more known values of required ANN 400 output signal, denoted herein as “Annotated data” 30. Training module 300 may compare an actual output 400A of ANN 400 to Annotated data 30, to calculate an error value 300A of the ANN 400 output signal 400A. Training module 300 may apply a training algorithm such as a Back-Propagation Gradient Descend (BPGD) algorithm to find the required weight values of ANN 400, which will produce a minimal error value 300A. Training module 300 may then control or adjust the value (e.g., impedance) of at least one physical property of one or more exponentiation circuits 110 as elaborated herein, to change the weight value according to the calculated, required weight value.

As elaborated herein (e.g., in relation to FIG. 5), the exponentiation factors n (e.g., n1, n2) of exponentiation modules 110 (e.g., 110A, 110B) may be determined by setting the values of their respective resistors R1, R2.

Training module 300 may receive the output 400A from at least one activation function circuit 130 of ANN 400, and use it for setting or adjusting the values of R1, R2 in order to change the values of power factors n1 and/or n2, and subsequently change a weight (e.g., Wi i∈[1, 6] of FIG. 8) of the relevant node circuit 100.

Additionally, or alternatively, I_{ref} element of multiplication circuit 120 (e.g., I_{ref} element of FIG. 6) may be an adjustable current source. According to some embodiments, training module 300 may adjust a current value of the I_{ref} element in multiplication circuit 120, to change a weight (e.g., Wi i∈[1, 6] of FIG. 8) of the relevant node circuit 100.

Training module 300 may thus change a configuration (e.g., one or more weights) of at least one perceptgene or node circuit 100 of ANN 400 as needed according to the training (e.g., BPGD) algorithm.

In other words, training module 300 may be configured to: receive an input vector, which may include one or more input signals (e.g., elements [X1, X2, X3] of FIG. 8, [Iin1, Iin2] of FIG. 9) of the two or more exponentiation analog circuits 110 (e.g., 110A, 110B). Training module 300 may also receive supervisory, or annotated data 30, corresponding to the input vector, in a sense that annotated data 30 may represent a required output of at least one perceptgene 100 of ANN 400, given the input data vector (e.g., [Iin1, Iin2]). In other words, supervisory data 30 may represent a desired value of one or more activation signals (e.g., 400A, IPG_Out), in response to the data vector (e.g., [Iin1, Iin2]).

Training module 300 may subsequently adjust a weight hardware element (e.g., change an impedance of R1 and/or R2) of at least one exponentiation analog circuit 110, based on input vector (e.g., [Iin1, Iin2]) and the supervisory data 30 (e.g., based on the calculated error 300A, according to a BPGD algorithm), to train ANN circuit 400, as elaborated herein.

It may be appreciated by a person skilled in the art that such training of ANN circuit 400 may configure ANN circuit 400 to implement an AI function or ML function of interest. In other words, ANN circuit 400 may be trained such that output signal 400A may represent application of a desired AI function (e.g., a classification function) on the one or more input signals (e.g., elements [X1, X2, X3]).

Additionally, or alternatively, at least one exponentiation circuit 110 may include an adjustable bias hardware element, such as an adjustable transistor or resistor (e.g., VCR or CCR). The adjustable bias hardware element may be configured to determine a bias value (e.g., Bi, i∈1, 2) of the relevant exponentiation circuit 110 of node circuit 100. In some embodiments, training module may adjust a value (e.g., an impedance) of the bias hardware element as part of the training process, based on the input vector (e.g., [Iin1, Iin2]) and supervisory data 30.

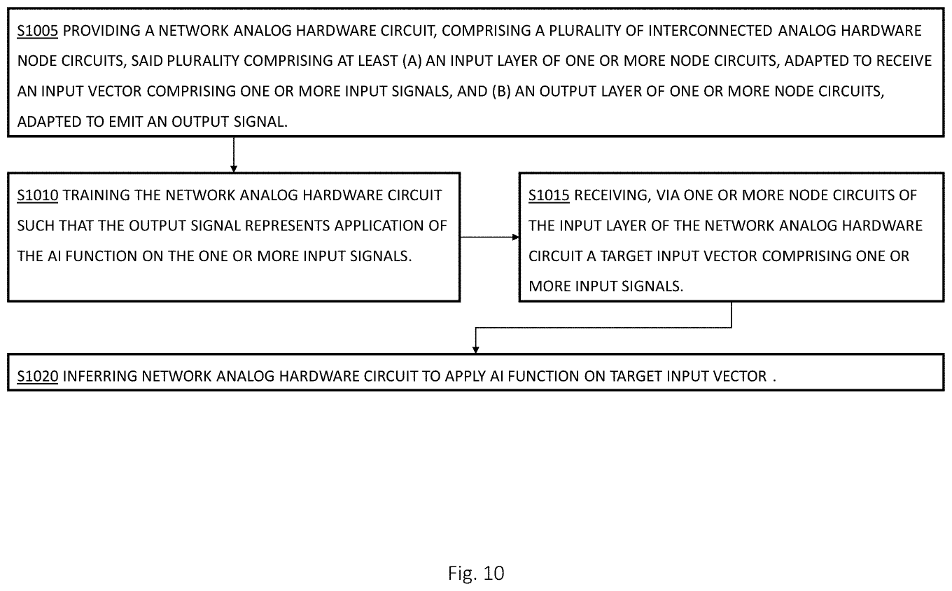

Reference is now made to FIG. 10, which is a flow diagram depicting a method of implementing an Artificial Intelligence (AI) function or ML function, according to some embodiments of the invention.

As shown in step S1005, embodiments of the method may include providing a network analog hardware circuit 400, also referred to herein as an ANN analog hardware circuit 400 or ANN circuit 400. As elaborated herein (e.g., in relation to FIG. 8), ANN circuit 400 may include a plurality of interconnected analog hardware node circuits 100 or perceptgene circuits 100. As shown in FIG. 8, the plurality of node circuits 100 may include an input layer (e.g., denoted “Layer 1”) of node circuits, adapted to receive an input vector (denoted Vi=[X1, X2, X3]), comprising one or more input signals (e.g., X1, X2, X3). The plurality of node circuits 100 may further include an output layer of node circuits 100, adapted to emit an output signal 400A.

As shown in step S1010, embodiments of the method may include a training stage, where the network analog hardware circuit 400 may be trained, e.g., by training circuit or module 300 of FIG. 9, to emit an output signal 400A. As elaborated herein (e.g., in relation to FIG. 9) ANN circuit 400 may be trained such that output signal 400A represents application of a desired AI function on the one or more input signals (X1, X2, X3).

For example, output signal output signal 400A may represent a classification of vector Vi and/or the one or more input signals (e.g., X1, X2, X3), according to one or more predetermined classes or class types. The process of training network analog hardware circuit 400 is elaborated herein, e.g., in relation to FIG. 9, and will not be repeated here for the purpose of brevity.

As shown in steps S1015 and S1020, embodiments of the method may include an inference stage, where the network analog hardware circuit 400 may be inferred on one or more target input vectors. In other words, during an inference stage, ANN circuit 400 may receive, e.g., via one or more node circuits 100 of input layer (“Layer 1”) of the network analog hardware circuit 400 a target input vector Vin, which may include one or more target input signals (e.g., X1, X2, X3). As shown in step S1020, embodiments of the method may include inferring ANN circuit 400 on target input vector Vin, so as to apply the AI or ML function of interest on target input vector Vi. In other words, during the inference stage, output signal 400A may represent an outcome of the predetermined AI or ML function (e.g., classification) of at least one input signal (e.g., X1, X2, X3) of input vector Vi.

As elaborated herein (e.g., in relation to FIG. 8), ANN circuit 400 may include a plurality of node circuits 100. Additionally, one or more (e.g., each) node circuit 100 of the plurality of node circuits may include two or more exponentiation analog circuits (e.g., 110, 110′) configured to work in a translinear work mode, and at least one multiplication analog circuit (e.g., 120, 120′) configured to work in a translinear work mode. Additionally, one or more (e.g., each) node circuit 100 of the plurality of node circuits 100 may include an activation analog circuit 130, configured to emit an activation signal (denoted herein as IPG_Out), based on a multiplication signal output of the at least one said multiplication analog circuit (e.g., 120, 120′).

According to some embodiments, according to some embodiments, output signal 400A may include, may be, or may be derived based on activation signal IPG_Out of node circuits 100 of the output layer (e.g., “Layer 2”).

As elaborated herein, ANN circuit 400 may be trained to implement an AI function or ML function of interest. According to some embodiments, the AI function or ML function of interest may be, or may include prediction of an outcome of a biochemical process, such as synthesis of proteins in a simulated biological environment.

In such embodiments, at least one input signal (e.g., X1, X2, X3) may be, or may represent a concentration parameter value, representing a concentration of a protein involved in the biochemical process. Additionally, or alternatively, at least one exponent value may be or may represent a hill coefficient of a protein involved in the biochemical process. Output signal 400, (e.g., the at least one activation signal IPG_Out of the plurality of node analog hardware circuits) may then be, or include a prediction value, which may represent a predicted outcome of the biochemical process. Pertaining to the same example, output signal 400 may represent a predicted rate or quantity of synthesized proteins in a simulated biological environment.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A hardware Artificial Neural Network (ANN) analog circuit comprising one or more interconnected node circuits, wherein at least one node circuit comprises:
two or more first analog circuits, each configured to receive a respective input signal, and produce an exponentiation signal representing a calculation of exponentiation of the respective input signal, by a predetermined respective exponent value;
a second analog circuit, configured to produce a multiplication signal, representing a product of the exponentiation signals of the two or more first translinear analog circuits; and
a third analog circuit, configured to output an activation signal, based on said multiplication signal.

2. The ANN analog circuit of claim 1, wherein the two or more first analog circuits are translinear analog circuits, and wherein the second analog circuit is a translinear analog circuit.

3. The ANN analog circuit of claim 1, wherein the two or more first analog circuits each comprise one or more transistors, tuned to operate in the transistor subthreshold region, thus producing said exponentiation signal in a translinear work mode.

4. The ANN analog circuit of claim 1, wherein the second analog circuit comprises one or more transistors, tuned to operate in the transistor subthreshold region, thus producing said multiplication signal in a translinear work mode.

5. The ANN analog circuit of claim 1, wherein the one or more node circuits are interconnected such that the output activation signal of at least one first node circuit serves as an input signal of at least one second node circuit.

6. The ANN analog circuit of claim 1, further comprising:
an input layer of node circuits, adapted to receive an input vector comprising one or more input signals; and
an output layer of node circuits, adapted to emit an output signal based on the activation signal of the output layer node circuits,
wherein the ANN circuit is trained such that the output signal represents a classification of the one or more input signals.

7. The ANN analog circuit of claim 1, wherein the two or more first analog circuits comprise an adjustable weight hardware element, determining the exponent value.

8. The ANN analog circuit of claim 7, further comprising a training module, configured to train the ANN by:
receiving an input vector, comprising one or more input signals of the two or more first analog circuits;
receiving supervisory data, corresponding to the input vector, wherein said supervisory data represents a desired value of one or more activation signals, in response to the input vector; and
adjusting the weight hardware element of at least one first analog circuit, based on the input vector and the supervisory data.

9. The ANN analog circuit of claim 8, wherein at least one first analog circuit comprises an adjustable bias hardware element, determining a bias value of the first analog circuit, and wherein the training module is further configured to adjust the bias hardware element of at least one first analog circuit, based on the input vector and the supervisory data.

10. The ANN analog circuit of claim 8, wherein adjusting the weight hardware element comprises adjusting an impedance of the weight hardware element, so as to redetermine the exponent value of the relevant first analog circuit.

11. A node analog hardware circuit comprising:
two or more exponentiation analog circuits, each configured to receive a respective input signal, and produce an exponentiation signal representing a calculation of exponentiation of the respective input signal, by a predetermined, respective exponent value;
a multiplication analog circuit, configured to produce a multiplication signal, representing a product of the exponentiation signals of the two or more exponentiation analog circuits; and
an activation analog circuit, configured to output an activation signal based on said multiplication signal,
wherein said exponentiation analog circuits and multiplication analog circuit are configured to work in a translinear work mode, and wherein said activation signal represents a predicted value of a product of a biochemical process.

12. The node analog hardware circuit of claim 11, wherein said activation signal represents a predicted value of a product of the biochemical process, according to the Michaelis-Menten function.

13. The node analog hardware circuit of claim 11, wherein at least one input signal is a concentration parameter value, representing a concentration of a protein involved in the biochemical process.

14. The node analog hardware circuit of claim 11, wherein at least one exponent value represents a hill coefficient of a protein involved in the biochemical process.

15. A method of implementing an Artificial Intelligence (AI) function, the method comprising:
providing a network analog hardware circuit, comprising a plurality of interconnected analog hardware node circuits, said plurality comprising at least (a) an input layer of node circuits, adapted to receive an input vector comprising one or more input signals, and (b) an output layer of node circuits, adapted to emit an output signal; and
training the network analog hardware circuit such that the output signal represents application of the AI function on the one or more input signals.

16. The method of claim 15 wherein one or more node circuits of the plurality of node circuits comprises:
two or more exponentiation analog circuits, each configured to receive a respective input signal, and produce an exponentiation signal representing a calculation of exponentiation of the respective input signal, by a predetermined, respective exponent value; and
a multiplication analog circuit, configured to produce a multiplication signal, representing a product of the exponentiation signals of the two or more exponentiation analog circuits,
wherein said exponentiation analog circuits and multiplication analog circuit are configured to work in a translinear work mode.

17. The method of claim 16, wherein one or more node circuits of the plurality of node circuits comprise an activation analog circuit, configured to emit an activation signal based on said multiplication signal, and wherein the output signal comprises the activation signal of the output layer node circuits.

18. The method of claim 17 wherein at least one input of a first node analog hardware circuit comprises a weighted function of one or more activation signals output by one or more respective second node analog hardware circuits.

19. The method of claim 17, wherein the AI function comprises prediction of an outcome of a biochemical process, and wherein at least one input signal is a concentration parameter value, representing a concentration of a protein involved in the biochemical process, and wherein at least one exponent value represents a hill coefficient of a protein involved in the biochemical process.

20. The method of claim 19, wherein at least one activation signal of the plurality of node analog hardware circuits comprises a prediction value, representing a predicted outcome of the biochemical process.
